(19) United States
(12) Patent Application Publication
(10) Pub. No.: US 2026/0292892 A1
(43) Pub. Date: Sep. 24, 2026

(54) METHOD FOR DETERMINING PHYSICAL RANDOM ACCESS CHANNEL TRANSMISSION OCCASION RO RESOURCES, TERMINAL, AND NETWORK-SIDE DEVICE

(71) Applicant: VIVO MOBILE COMMUNICATION CO., LTD., Dongguan (CN)

(72) Inventors: Chengrui WANG, Dongguan (CN); Zhipeng LIN, Dongguan (CN); Yitao MO, Dongguan (CN)

(73) Assignee: VIVO MOBILE COMMUNICATION CO., LTD., Dongguan (CN)

(21) Appl. No.: 19/577,352

(22) Filed: Mar. 24, 2026

Related U.S. Application Data
(63) Continuation of application No. PCT/CN2024/120704, filed on Sep. 24, 2024.

(30) Foreign Application Priority Data
Sep. 27, 2023 (CN) 202311269913.9

(51) Int. Cl. H04W 74/0833; H04W 72/0453

(52) U.S. Cl. CPC H04W 74/0833; H04W 72/0453

(57) ABSTRACT

A method for determining physical random access channel transmission occasion (RO) resources, a terminal, and a network-side device are provided. The method for determining the RO resources includes: receiving, by a terminal, target indication information. The target indication information includes a Physical Random Access Channel (PRACH) mask index, and the PRACH mask index indicates RO resources during PRACH repetition. The method further includes determining a target RO group based on the PRACH mask index. The target RO group is used for the PRACH repetition.

### CROSS-REFERENCE TO RELATED APPLICATIONS

This application is a continuation of International Application No. PCT/CN2024/120704, filed on Sep. 24, 2024, which claims priority to Chinese patent application No. 202311269913.9, filed with the China National Intellectual Property Administration on Sep. 27, 2023. The entire contents of each of the above-referenced applications are expressly incorporated herein by reference.

### TECHNICAL FIELD

This application belongs to the field of communication technologies, and in particular, to a method for determining physical random access channel transmission occasion (RO) resources, a terminal, and a network-side device.

### BACKGROUND

In a related technology, for a contention-free random access procedure, a network device sends, to a terminal, information carrying a preamble index and a Physical Random Access Channel (PRACH) mask index, to indicate the terminal to send a preamble corresponding to the preamble index on a PRACH resource indicated by the PRACH mask index. In addition, the network device usually sends the foregoing information to the terminal device over a Physical Downlink Control Channel (PDCCH) or by using Radio Resource Control (RRC) signaling.

However, in a PRACH resource indication solution provided in the related technology, a PRACH transmission occasion (or may be a PRACH occasion or RO) is indicated only for a single PRACH transmission, but is not applicable to PRACH repetition. Consequently, communication performance is affected.

### SUMMARY

Embodiments of this application provide a method for determining RO resources, a terminal, and a network-side device, to indicate the RO resources used for PRACH repetition, thereby ensuring communication performance.

According to a first aspect, a method for determining RO resources is provided, including: receiving, by a terminal, target indication information, where the target indication information includes a physical random access channel PRACH mask index, and the PRACH mask index indicates RO resources during PRACH repetition; and determining a target RO group based on the PRACH mask index, where the target RO group is used for the PRACH repetition.

According to a second aspect, a method for determining RO resources is provided, including: sending, by a network-side device, target indication information, where the target indication information includes a physical random access channel PRACH mask index, and the PRACH mask index indicates RO resources during PRACH repetition.

According to a third aspect, an apparatus for determining RO resources is provided, including: a receiving module, configured to receive target indication information, where the target indication information includes a physical random access channel PRACH mask index, and the PRACH mask index indicates RO resources during PRACH repetition; and a determining module, configured to determine a target RO group based on the PRACH mask index, where the target RO group is used for the PRACH repetition.

According to a fourth aspect, an apparatus for determining RO resources is provided, including: a sending module, configured to send target indication information, where the target indication information includes a physical random access channel PRACH mask index, and the PRACH mask index indicates RO resources during PRACH repetition.

According to a fifth aspect, a terminal is provided. The terminal includes a processor and a memory. The memory stores a program or instructions that can be run on the processor, and in a case that the program or the instructions are executed by the processor, steps of the method according to the first aspect are implemented.

According to a sixth aspect, a terminal is provided. The terminal includes a processor and a communication interface. The communication interface is coupled to the processor, and the processor is configured to run a program or instructions, to implement steps of the method according to the first aspect.

According to a seventh aspect, a network-side device is provided. The network-side device includes a processor and a memory. The memory stores a program or instructions that can be run on the processor, and in a case that the program or the instructions are executed by the processor, steps of the method according to the second aspect are implemented.

According to an eighth aspect, a network-side device is provided, including a processor and a communication interface. The communication interface is coupled to the processor, and the processor is configured to run a program or instructions, to implement steps of the method according to the second aspect.

According to a ninth aspect, a readable storage medium is provided. The readable storage medium stores a program or instructions, and in a case that the program or the instructions are executed by a processor, steps of the method according to the first aspect or steps of the method according to the second aspect are implemented.

According to a tenth aspect, a wireless communication system is provided, including: a terminal and a network-side device. The terminal may be configured to perform steps of the method according to the first aspect, and the network-side device may be configured to perform steps of the method according to the second aspect.

According to an eleventh aspect, a chip is provided. The chip includes a processor and a communication interface. The communication interface is coupled to the processor, and the processor is configured to run a program or instructions, to implement steps of the method according to the first aspect or steps of the method according to the second aspect.

According to a twelfth aspect, a computer program/program product is provided. The computer program/program product is stored in a storage medium. The program/program product is executed by at least one processor, to implement steps of the method according to the first aspect or steps of the method according to the second aspect.

In embodiments of this application, the terminal receives the target indication information, and determines the target RO group based on the RO resources indicated by the PRACH mask index in the target indication information. Therefore, the RO resources during the PRACH repetition can be indicated, so that the terminal and the network-side device have the same understanding of the RO resources during the PRACH repetition, thereby ensuring communication performance.

### BRIEF DESCRIPTION OF THE DRAWINGS

FIG. 1 is a schematic diagram of a structure of a wireless communication system according to an example embodiment of this application;

FIG. 2 is a schematic flowchart 1 of a method for determining RO resources according to an example embodiment of this application;

FIG. 3 is a schematic flowchart 2 of a method for determining RO resources according to an example embodiment of this application;

FIG. 4a is a schematic diagram 1 of an indication manner of RO resources according to an example embodiment of this application;

FIG. 4b is a schematic diagram 2 of an indication manner of RO resources according to an example embodiment of this application;

FIG. 4c is a schematic diagram 3 of an indication manner of RO resources according to an example embodiment of this application;

FIG. 5 is a schematic flowchart 3 of a method for determining RO resources according to an example embodiment of this application;

FIG. 6 is a schematic diagram 4 of an indication manner of RO resources according to an example embodiment of this application;

FIG. 7 is a schematic flowchart 4 of a method for determining RO resources according to an example embodiment of this application;

FIG. 8 is a schematic diagram 1 of a structure of an apparatus for determining RO resources according to an example embodiment of this application;

FIG. 9 is a schematic diagram 2 of a structure of an apparatus for determining RO resources according to an example embodiment of this application;

FIG. 10 is a schematic diagram of a structure of a communication device according to an example embodiment of this application;

FIG. 11 is a schematic diagram of a structure of a terminal according to an example embodiment of this application; and

FIG. 12 is a schematic diagram of a structure of a network-side device according to an example embodiment of this application.

### DETAILED DESCRIPTION

The following clearly describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application fall within the protection scope of this application.

The terms “first”, “second”, and the like in this application are intended to distinguish similar objects, but are not necessarily used to describe a specific order or sequence. It should be understood that terms used in such a way are interchangeable in proper circumstances, so that embodiments of this application described herein can be implemented in an order different from the order illustrated or described herein. In addition, the objects distinguished by “first” and “second” are usually one category, and a quantity of objects is not limited. For example, the first object may be one or more. In addition, “or” in this application indicates at least one of connected objects. For example, “A or B” covers three solutions, that is, solution 1: including A and excluding B; solution 2: including B and excluding A; and solution 3: including both A and B. The character “/” in this specification generally indicates an “or” relationship between associated objects.

The term “indication” in this application may be a direct indication (or an explicit indication), or may be an indirect indication (or an implicit indication). The direct indication may be understood as that a transmitter explicitly notifies a receiver of content such as specific information, an operation that needs to be performed, or a request result in a sent indication. The indirect indication may be understood as that a receiver determines corresponding information according to an indication sent by a transmitter, or performs determining and determines an operation that needs to be performed or a request result according to a determining result.

It should be noted that, the technology described in embodiments of this application is not limited to being used in a Long Term Evolution (LTE)/LTE-Advanced (LTE-A) system, and may be further applied to another wireless communication system, for example, a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency-Division Multiple Access (SC-FDMA) system, or another system. The terms “system” and “network” are often interchangeably used in embodiments of this application, and the technology described may be used for both the system and radio technology mentioned above, and used for another system and radio technology. The following descriptions describe a New Radio (NR) system for purposes of example, and the term of NR is used in most of the following descriptions, but these technologies are also applicable to a system beyond the NR system, for example, a 6th Generation (6G) communication system.

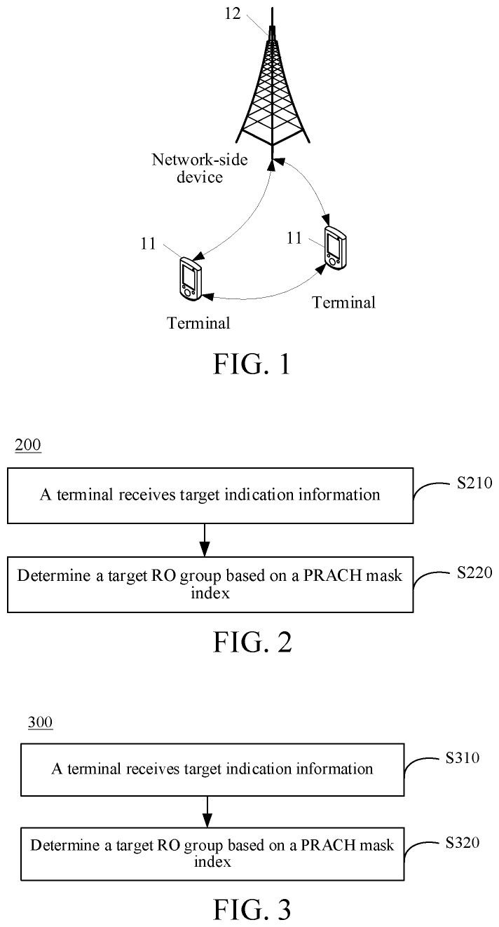

FIG. 1 is a block diagram of a wireless communication system to which an embodiment of this application is applicable. The wireless communication system includes a terminal 11 and a network-side device 12. The terminal 11 may be a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a flight vehicle, an in-vehicle device/Vehicle User Equipment (VUE), a ship device, Pedestrian User Equipment (PUE), a smart home appliance (a home device with a wireless communication function, such as a refrigerator, a television, a washing machine, furniture, or the like), a game console, a Personal Computer (PC), a teller machine, a self-service machine, or another terminal-side device. The wearable device includes: a smart watch, a smart band, smart headphones, smart glasses, smart jewelry (a smart bangle, a smart bracelet, a smart ring, a smart necklace, a smart ankle bracelet, a smart anklet, and the like), a smart wristband, smart clothing, and the like. The in-vehicle device may be referred to as an in-vehicle terminal, an in-vehicle controller, an in-vehicle module, an in-vehicle component, an in-vehicle chip, an in-vehicle unit, or the like. It should be noted that, a specific type of the terminal 11 is not limited in embodiments of this application. The network-side device 12 may include an access network device or a core network device. The access network device may be referred to as a Radio Access Network (RAN) device, a radio access network function, or a radio access network unit. The access network device may include a base station, a Wireless Local Area Network (WLAN) Access Point (AP), a Wireless Fidelity (Wi-Fi) node, or the like. The base station may be referred to as a Node B (NB), an evolved Node B (eNB), a next generation Node B (gNB), a New Radio Node B (NR Node B), an access point, a Relay Base Station (RBS), a Serving Base Station (SBS), a Base Transceiver Station (BTS), a radio base station, a radio transceiver, a Basic Service Set (BSS), an Extended Service Set (ESS), a Home Node B (HNB), a home evolved Node B, a Transmission Reception Point (TRP) or some other suitable terms in the field as long as the same technical effect is achieved, and the base station is not limited to a specific technical word. It is to be noted that, in embodiments of this application, an example of a base station in the NR system is used for description, and the specific type of the base station is not limited.

In view of this, for ease of understanding, related technical features subsequently mentioned in this application are described herein, and the content is as follows.

### (1) Contention Based Random Access (CBRA) Procedure.

In a 4-step contention-based random access procedure, a terminal first sends a message (Msg) 1, that is, a preamble, to a network side on RO resources. After detecting the preamble, the network side sends an Msg 2/Random Access Response (RAR) message, including a number of the preamble detected by the network and an uplink radio resource allocated to an Msg 3 sent by the terminal. After receiving the Msg 2, the terminal confirms that at least one preamble carried in the Msg 2 has the same number as the preamble sent by the terminal, and sends the Msg 3 including contention-based resolution information based on the resource indicated by the RAR. After receiving the Msg 3, the network sends an Msg 4 including contention-based resolution information. The terminal receives the Msg 4, and confirms that the contention-based resolution information is the same as that sent by the terminal in the Msg 3. In this case, 4-step random access is completed.

The network includes Uplink grant (UL grant) information in the RAR, used for indicating Msg 3 Physical Uplink Shared Channel (PUSCH) scheduling information, and includes information such as a RACH preamble Identifier (ID), a Temporary Cell Radio Network Temporary Identifier (TC-RNTI), Timing Advance (TA), and the like. If the network does not receive the Msg 3 PUSCH, the network may schedule retransmission of the Msg 3 PUSCH over a PDCCH scrambled by a TC-RNTI.

### (2) Contention Free Random Access (CFRA) Procedure

For a contention-based random access procedure, different terminals randomly select preambles for transmission. In this way, the different terminals may select a same preamble for transmission on a same RO resource. This may be understood as a preamble collision between the terminals. In this case, different terminals receive a same RAR, and different terminals transmit the Msg 3 PUSCH based on scheduling information in the RAR UL grant. Because the existing technology does not support repetitions of the Msg 3 PUSCH, and the network can only solve, on one Msg 3 PUSCH scheduling resource, a PUSCH (including contention-based resolution information) sent by one terminal, the network includes, in an Msg 4, contention-based resolution information received in the Msg 3. If the contention-based resolution information received by the terminal in the Msg 4 matches the contention-based resolution information sent by the terminal in the Msg 3 PUSCH, the terminal considers that the contention-based resolution succeeds. If the information does not match, it is considered that the contention-based resolution fails.

If the contention-based resolution fails, the terminal reselects resources for PRACH transmission, and performs a next random access attempt.

### (3) Selection of Random Access Resources

In an NR, a cell may configure a plurality of Frequency Division Multiplex (FDM) ROs at a time-domain position for PRACH transmission, briefly referred to as the RO herein for simplicity. At a time point, a quantity of ROs on which FDM may be performed may be {1, 2, 4, 8}, and the quantity is configured and determined by using a higher layer parameter msg 1-FDM.

The random access preamble can be transmitted only on time-domain resources configured by a parameter PRACH configuration index (ConfigurationIndex), and the random access preamble can be transmitted only on frequency-domain resources configured by the parameter msg 1-FDM.

During initial access, the PRACH frequency-domain resources are numbered in ascending order from the lowest-frequency RO resource in an initial active uplink bandwidth part; or the PRACH frequency-domain resources are numbered in ascending order from the lowest-frequency RO resource in an active uplink bandwidth part.

In the NR, there is an association relationship between the RO and an actually sent Synchronization Signal and PBCH block (SSB). That is, the ROs are sorted in an order of frequency domain (from a low frequency to a high frequency) and then time domain, and one SSB may be associated with a plurality of consecutive ROs, or a plurality of SSBs are associated with one RO. In this case, different SSBs correspond to different preambles. For example, oneEighth represents that one SSB is associated with eight consecutive ROs, and eight represents that eight SSBs are associated with one RO. After all SSBs are associated with ROs for one round, an SSB-RO mapping cycle is formed. One SSB-RO association period may include one or more SSB-RO mapping cycles. One SSB-RO association pattern period may include one or more SSB-RO association periods.

Usually, a base station may send different SSBs by using different beams, where a quantity of SSBs is configured by using an ssb-PositionsInBurst (PositionsInBurst) parameter, and for FR 2, the maximum quantity of SSBs is 64. A corresponding terminal sends a preamble on an RO associated with an SSB. In this way, the terminal selects, based on strength of a received downlink beam or SSB, an RO/“RO and preamble” associated with an SSB with a strong signal, to send the Msg 1. In this way, the network may determine, based on the received RO of the preamble/“RO and preamble”, an SSB selected by the terminal. In addition, the Msg 2 is sent on a downlink beam corresponding to the SSB, to ensure reception quality of a downlink signal.

Before sending the PRACH, the terminal first performs resource selection, and first selects, based on a Reference Signal Received Power (RSRP) of a received beam or SSB, an SSB with the RSRP higher than a threshold. If RSRPs of a plurality of SSBs are higher than the threshold, the terminal may select any SSB with the RSRP higher than the threshold. In a case that there is no SSB with the RSRP higher than the threshold, the terminal selects an SSB based on implementation.

Based on the configuration on the network side, the terminal obtains a correspondence between an SSB and an RO. After the terminal selects the SSB, an RO corresponding to the selected SSB is used as an RO for sending a PRACH (or preamble). If the selected SSB is associated with a plurality of ROs, the terminal may select one of the ROs to send the PRACH (or preamble).

In view of this, technical solutions according to embodiments of this application are described in detail below by using some embodiments and application scenarios thereof with reference to the accompanying drawings.

FIG. 2 is a schematic flowchart of a method 200 for determining RO resources according to an example embodiment of this application. The method 200 may be, but is not limited to, performed by a terminal, and may be performed by hardware or software installed in the terminal. In this embodiment, the method 200 may include at least the following steps.

S210: A terminal receives target indication information.

The target indication information may be sent by a network-side device. The target indication information includes, but is not limited to, a PRACH mask index, indicating RO resources during PRACH repetition.

In this embodiment, there may be a plurality of indication granularities in a case that the RO resources are indicated by the PRACH mask index. For example, an RO group or an RO set may be used as a granularity for indication. That is, the RO resources indicated by the PRACH mask index include an RO group, and the RO group includes a plurality of ROs used during the PRACH repetition.

For another example, the indication may be performed by using an RO as a granularity. That is, the RO resources indicated by the PRACH mask index may include one or more ROs. In view of this, the terminal may further determine, based on the indicated one or more ROs, an RO group used during the PRACH repetition.

It may be understood that, assuming that a plurality of ROs are pre-configured for the terminal, for the foregoing case in which the RO is used as the granularity for indication, the plurality of ROs indicated by the PRACH mask index may respectively belong to different RO groups or a same RO group. This is not limited herein.

In some embodiments, the PRACH mask index provided in this embodiment may be applicable to, but is not limited to, an RO resource indication during the PRACH repetition in a target range or scenario. The target range or scenario includes at least one of the following (01) to (05).

(01) A target time period, where the target time period is a time period for determining the target RO group.

(02) Preset M RO groups, where M is an integer greater than or equal to 1.

In this embodiment, a manner of determining the MRO groups may include: for each SSB, every M consecutive RO groups associated with the SSB may be numbered as a unit, that is, the preset M RO groups.

(03) At least one SSB-RO mapping cycle.

(04) At least one SSB-RO association period.

(05) At least one SSB-RO association pattern period.

It may be understood that, in this application, the target time period may include one or more SSB-RO association pattern periods, where one SSB-RO association pattern period may include one or more SSB-RO association periods, and one SSB-RO association period may include one or more SSB-RO mapping cycles. This is not limited herein.

S220: Determine a target RO group based on the PRACH mask index.

The target RO group is used for the PRACH repetition. That is, in this embodiment, the RO resources during the PRACH repetition can be indicated by the PRACH mask index, so that the terminal and the network-side device have the same understanding of the RO resources during the PRACH repetition, thereby ensuring the communication performance.

It should be noted that, in this embodiment, manners of determining the target RO group may be different based on different indication granularities or units indicated by the PRACH mask index. This is not limited herein.

In addition, in some embodiments, in a case that the RO resources during the PRACH repetition are indicated by the PRACH mask index, and the RO resources are shared in a 2-step random access procedure and a 4-step random access procedure, the RO resources indicated by the PRACH mask index are used in the 2-step random access procedure, and are not used in the 4-step random access procedure. That is, for the PRACH repetition in the 2-step random access procedure and the 4-step random access procedure, in a case that the RO resources indicated by the PRACH mask index are shared by the two procedures, the 2-step random access procedure has a higher priority. That is, the RO resources are only used for the PRACH repetition in the 2-step random access procedure but cannot be used for the PRACH repetition in the 4-step random access procedure, thereby avoiding a resource collision, and ensuring the random access performance of the 2-step random access procedure.

In addition, the PRACH mask mentioned in the context of this application may be a PRACH mask configured in CBRA, or a PRACH mask configured in CFRA. This is not limited herein.

In this embodiment, the terminal receives the target indication information, and determines the target RO group based on the RO resources indicated by the PRACH mask index in the target indication information. Therefore, the RO resources during the PRACH repetition can be indicated, so that the terminal and the network-side device have the same understanding of the RO resources during the PRACH repetition, thereby ensuring communication performance.

FIG. 3 is a schematic flowchart of a method 300 for determining RO resources according to an example embodiment of this application. The method 300 may be, but is not limited to, performed by a terminal, and may be performed by hardware or software installed in the terminal. In this embodiment, the method 300 may include at least the following steps.

S310: A terminal receives target indication information.

The target indication information includes a PRACH mask index, and the PRACH mask index indicates RO resources during PRACH repetition.

S320: Determine a target RO group based on the PRACH mask index.

The target RO group is used for the PRACH repetition.

It may be understood that, for implementation processes of S310 and S320, refer to related descriptions in the foregoing method embodiment 200, and the same or corresponding technical effects can be achieved. In addition to referring to the related descriptions in the foregoing method embodiment 200, in some embodiments, there may be a plurality of manners for indicating the RO resources indicated by the PRACH mask index based on different indication granularities in a case that the PRACH mask index indicates the RO resources. The following describes processes of indicating the RO resources for different indication granularities with reference to an implementation 1 and an implementation 2.

### Implementation 1: Indication Granularity is an RO Group

In a case that the PRACH mask index indicates that an indication granularity of the RO resources is an RO group, and a plurality of RO groups are configured in the terminal, an RO group used during the PRACH repetition may be indicated by the PRACH mask index corresponding to a RO group index or by using the PRACH mask index as a specific value or a specific bit. The group index mentioned in the context of this application is used to identify or uniquely identify the RO group. The specific value can be determined through protocol agreement, a higher-layer configuration, or a network-side configuration.

In view of this, in some embodiments, the PRACH mask index may be indicated by, but is not limited to, at least one of the following Manner 1 to Manner 4.

Manner 1: Indicating that all RO groups associated with the SSB are available. The SSB is related to the PRACH repetition.

For example, assuming that the PRACH mask index is a first specific value, for example, 13, the terminal determines that the PRACH mask index indicates that all RO groups associated with the SSB are available.

Manner 2: Indicating that an RO group associated with the SSB with a group index of an odd number is available.

For example, assuming that the PRACH mask index is a second specific value, for example, 14, the terminal determines that the PRACH mask index indicates that the RO group associated with the SSB with a group index of an odd number is available. For example, assuming that the RO groups associated with the SSB include an RO group 1, an RO group 2, an RO group 3, and an RO group 4, the PRACH mask index indicates that the RO group 1 and the RO group 3 are available.

Manner 3: Indicating that an RO group associated with the SSB with a group index of an odd number is available.

For example, assuming that the PRACH mask index is a third specific value, for example, 15, the terminal determines that the PRACH mask index indicates that the RO group associated with the SSB with a group index of an even number is available. For example, assuming that the RO groups associated with the SSB include an RO group 1, an RO group 2, an RO group 3, and an RO group 4, the PRACH mask index indicates that the RO group 2 and the RO group 4 are available.

Manner 4: Indicating that a specific RO group in a target range or scenario is available.

The target range may be determined through protocol agreement, a higher-layer configuration, a network-side configuration, or the like. For example, in this embodiment, the target range or scenario may include, but is not limited to, at least one of the following (11) to (15).

(11) A target time period, where the target time period is a time period for determining the target RO group. That is, the PRACH mask index may indicate that one or more RO groups in the target time period are available.

(12) Preset M RO groups, where M is an integer greater than or equal to 1. That is, the PRACH mask index may indicate that one or more of the M RO groups are available.

In this embodiment, a manner of determining the MRO groups may include: for each SSB, every M consecutive RO groups associated with the SSB may be numbered as a unit, that is, the preset M RO groups.

(13) At least one SSB-RO mapping cycle. That is, the PRACH mask index may indicate that one or more RO groups in at least one SSB-RO mapping cycle are available.

(14) At least one SSB-RO association period. That is, the PRACH mask index may indicate that one or more RO groups in at least one SSB-RO association period are available.

(15) At least one SSB-RO association pattern period. That is, the PRACH mask index may indicate that one or more RO groups in at least one SSB-RO association pattern period are available.

In addition, for Manner 1 to Manner 4, in a case that the PRACH mask index indicates a plurality of available RO groups, the terminal may select an RO group from the plurality of RO groups through protocol agreement or autonomous determining, for the PRACH repetition.

For example, in a case that the terminal autonomously selects an RO group from the plurality of RO groups, the terminal may select an RO group from the plurality of RO groups as the target RO group in a manner of first sorting frequency domain and then time domain, or in a manner of first sorting time domain and then frequency domain.

In some embodiments, in a case that the indication granularity is an RO group, a size of the RO group indicated by the PRACH mask index corresponds to a quantity of repetitions of the PRACH repetition. For example, assuming that a quantity of PRACH repetitions configured by the network is {4}, a size of the RO group actually indicated by the PRACH mask index is the quantity of repetitions 4, that is, the RO group actually indicated by the PRACH mask index includes 4 ROs or 4 valid ROs.

In some alternative embodiments, a size of the RO group indicated by the PRACH mask index corresponds to a maximum quantity of repetitions in a plurality of different repetitions corresponding to the PRACH repetition. That is, the PRACH mask index is used as a common PRACH mask index. In a case that the PRACH mask index indicates a plurality of RO groups in different sizes, a size of the RO group actually indicated by the PRACH mask index corresponds to or is the same as a maximum quantity of repetitions in a plurality of different repetitions corresponding to the PRACH repetition. Therefore, by using one common PRACH mask index, in a case that a plurality of PRACH repetitions are configured, the complexity of indicating the RO resources by the PRACH mask index can be reduced.

For example, assuming that the quantity of PRACH repetitions configured by the network is {2, 4, 8}, and different repetitions use a common PRACH mask index to indicate the RO group, a size of the RO group actually indicated by the PRACH mask index is the maximum quantity of repetitions 8.

It may be understood that, the size of the foregoing RO group may be understood as a quantity of ROs or a quantity of valid ROs included in the RO group. This is not limited herein.

In this case, in a case that the size of the RO group indicated by the PRACH mask index corresponds to or is the same as the maximum quantity of repetitions in different repetitions, the terminal determines the target RO group based on the PRACH mask index, and the quantity of repetitions of the PRACH repetition performed by the terminal is less than the maximum quantity of repetitions, the terminal determines the target RO group based on a part of ROs in the RO group indicated by the PRACH mask index. The part of the ROs may be determined through a network configuration or protocol agreement.

For example, assuming that the quantity of PRACH repetitions configured by the network is {2, 4, 8}, and different repetitions use a common PRACH mask index to indicate the RO group, that is, a size of the RO group indicated by the PRACH mask index is 8, in a case that a quantity of PRACH repetitions actually performed by the terminal is 2, the terminal may use two ROs in the RO group indicated by the PRACH mask index to perform the PRACH repetition.

### Implementation 2: Indication Granularity is an RO

In a case that the PRACH mask index indicates that an indication granularity of the RO resources is an RO, the PRACH mask index may indicate one or more ROs. For example, a manner in which the PRACH mask index indicates the RO resources may be shown in Table 1.

It is assumed that the terminal is pre-configured with an association relationship between an SSB and a RO, and in each SSB-RO mapping cycle, ROs associated with each SSB are numbered first in frequency domain (from a low frequency to a high frequency) and then in time domain. In view of this, as shown in Table 1, the PRACH mask index value of 0 may represent that all ROs associated with the SSB are available.

The PRACH mask index value of 1 represents that the first RO associated with the SSB is available, and remaining ROs are unavailable.

The PRACH mask index value of 2 represents that the second RO associated with the SSB is available, and remaining ROs are unavailable.

The PRACH mask index value of 3 represents that the third RO associated with the SSB is available, and remaining ROs are unavailable.

The PRACH mask index value of 4 represents that the fourth RO associated with the SSB is available, and remaining ROs are unavailable.

The PRACH mask index value of 5 represents that the fifth RO associated with the SSB is available, and remaining ROs are unavailable.

The PRACH mask index value of 6 represents that the sixth RO associated with the SSB is available, and remaining ROs are unavailable.

The PRACH mask index value of 7 represents that the seventh RO associated with the SSB is available, and remaining ROs are unavailable.

The PRACH mask index value of 8 represents that the eighth RO associated with the SSB is available, and remaining ROs are unavailable.

The PRACH mask index value of 9 represents that ROs associated with the SSB with an even number are available.

The PRACH mask index value of 10 represents that ROs associated with the SSB with an odd number are available, and so on.

The PRACH mask index values of 11 to 15 are reserved bits.

TABLE 1
PRACH mask index value

| PRACH mask index | Allowed RO(s) of SSB |
|---|---|
| 0 | All |
| 1 | RO index 1 |
| 2 | RO index 2 |
| 3 | RO index 3 |
| 4 | RO index 4 |
| 5 | RO index 5 |
| 6 | RO index 6 |
| 7 | RO index 7 |
| 8 | RO index 8 |
| 9 | Each RO with index of an even number |
| 10 | Each RO with index of an odd number |
| 11 | Reserved bit |
| 12 | Reserved |
| 13 | Reserved |
| 14 | Reserved |
| 15 | Reserved |

In view of this, after receiving the PRACH mask index, the terminal considers that an indication granularity is an RO. Therefore, the terminal may further determine the target RO group based on the RO indicated by the PRACH mask index. A determining manner may include but is not limited to at least one of Manner 1 to Manner 3.

Manner 1: Use an available RO group including the ROs indicated by the PRACH mask index as the target RO group, where all ROs in the available RO group are after a current time point, and the current time point is a time point of receiving the target indication information.

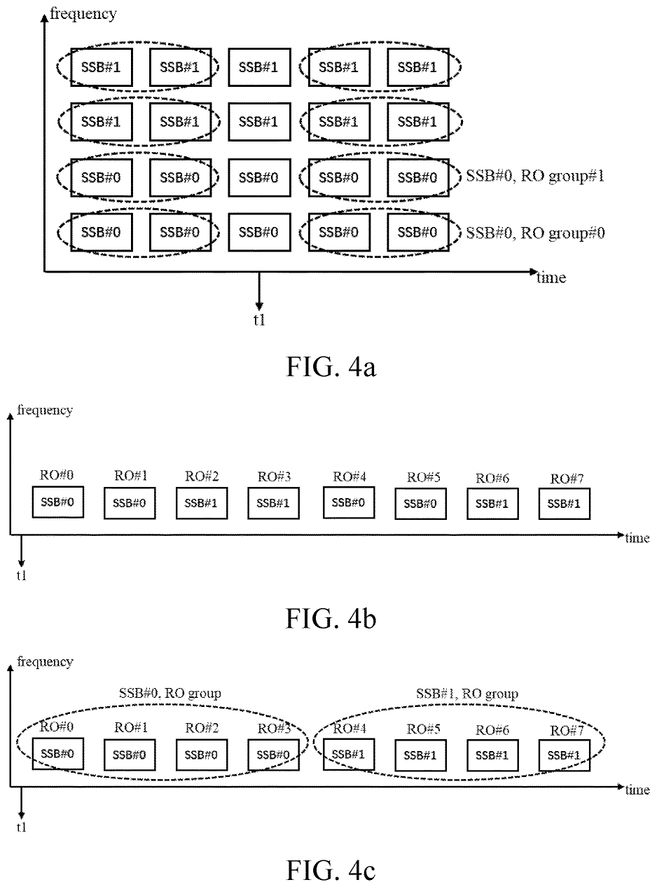

For example, an RO group having a lowest frequency position or a highest frequency position associated with the selected SSB may be selected. As shown in FIG. 4a, an RO resource indicated by the PRACH mask index at a current time point t1 is the first RO in an SSB-RO mapping cycle. Therefore, for an SSB #0, the terminal may select the SSB #0 RO group #0 at the lowest frequency position or the SSB #0 RO group #1 at the highest frequency position as the target RO group.

Manner 2: Use the RO indicated by the PRACH mask index as a starting RO, and determine the target RO group based on the starting RO.

For example, as shown in FIG. 4b, assuming that the quantity of PRACH repetitions is 2, and the RO resource indicated by the PRACH mask index at a current moment t1 is the second RO in the SSB-RO mapping cycle, for an SSB #0, the terminal may select RO #1 as the starting RO, and further determine {RO #1, RO #4} as the target RO group.

Manner 3: In a case that the PRACH mask index indicates the plurality of ROs, determine the target RO group based on available ROs in the plurality of ROs.

The plurality of ROs may be ROs corresponding to a same SSB-RO mapping cycle, or may be ROs respectively corresponding to different SSB-RO mapping cycles. This is not limited herein.

For example, each of the plurality of ROs corresponds to a different SSB-RO mapping cycle. In view of this, refer to FIG. 4b again. It is assumed that the quantity of PRACH repetitions is 2, and the RO resource indicated by the PRACH mask index at the current moment t1 is the second RO in the SSB-RO mapping cycle. Therefore, for the SSB #0, the RO #1 is the starting RO, the RO #4 is an unavailable RO, and the RO #5 is an available RO. Therefore, the terminal may combine the RO #1 and the RO #5 that correspond to different SSB-RO mapping cycles into one target RO group. For the SSB #1, the terminal may combine the RO #3 and the RO #7 corresponding to different SSB-RO mapping cycles into one target RO group.

It may be understood that, the terminal determines the target RO group in any one of Manner 1 to Manner 3, and the determining may be implemented through protocol agreement, a high-layer configuration, a network side configuration, or the like. This is not limited herein.

In a case that the terminal determines in advance that there is a first RO group, and the first RO group includes an unavailable RO and an available RO that are indicated by the PRACH mask index, the terminal may further perform any one of (21) to (23). Therefore, a problem that a terminal behavior is unclear is resolved in a case that the RO group includes an unavailable RO indicated by the PRACH mask index, to ensure the successful implementation of the PRACH repetition.

(21) The terminal determines the first RO group as the target RO group. That is, in a case that the target RO group is determined, unavailable ROs may be counted in the target RO group.

In view of this, in some embodiments, considering that unavailable ROs are also counted in the target RO group, that is, the target RO group includes available ROs and unavailable ROs, in a case that the terminal performs the operation of the PRACH repetition based on the determined target RO group, the operation may include, but is not limited to, at least one of Operation 1 to Operation 3.

Operation 1: The terminal performs the PRACH repetition on an available RO other than the unavailable RO in the target RO group. That is, the unavailable ROs indicated by the PRACH mask index may be counted in the target RO group, but the terminal actually performs the PRACH repetition on only the available ROs indicated by the PRACH mask index.

Operation 2: The terminal performs the PRACH repetition on an unavailable RO in the target RO group. That is, the terminal considers that the unavailable ROs indicated by the PRACH mask index are available and are counted in the target RO group, and the terminal actually performs the PRACH repetition on only the unavailable ROs.

Operation 3: The terminal performs the PRACH repetition on all ROs in the target RO group. That is, the terminal considers that the unavailable ROs indicated by the PRACH mask index are still available, and the terminal still performs the PRACH repetition on all ROs in the target RO group.

For example, refer to FIG. 4c. It is assumed that a quantity of ROs multiplexed in frequency domain is 1, and there are two SSBs in total, namely, an SSB #0 and an SSB #1. Each SSB is associated with four consecutive ROs, and in an SSB-RO mapping cycle, frequency-domain positions of the four ROs associated with each SSB are the same. In view of this, in a case that the RO resource indicated by the PRACH mask index at the current time point t1 is the first RO in the SSB-RO mapping cycle, for example, for the SSB #0, only the RO #0 is available, and the RO #1, the RO #2, and the RO #3 are unavailable. In this case, the terminal may combine the RO #0, the RO #1, the RO #2, and the RO #3 into one target RO group, that is, the unavailable RO #1, the RO #2, and the RO #3 are still counted.

In view of this, for the SSB #0, the terminal may send the PRACH only on the RO #0 in the target RO group, or send the PRACH on the RO #1, the RO #2, and the RO #3 in the target RO group, or send the PRACH on the RO #0, the RO #1, the RO #2, and the RO #3 in the target RO group.

It should be noted that, in a case that a quantity of ROs available for PRACH transmission in the determined target RO group is less than the preset PRACH repetitions, the actual quantity of PRACH transmission times may be less than the preset PRACH repetitions.

(22) Determine the target RO group based on the available RO in the first RO group and an available RO in a second RO group, where the second RO group is located after the first RO group in time.

That is, in a case that the target RO group is determined, the unavailable ROs are not counted in the target RO group. In view of this, for the successful implementation of the PRACH repetition, to avoid that the size of the target RO group determined based on the available ROs in the first RO group is less than a quantity of PRACH repetitions, therefore in this application, the target RO group may be determined based on the available RO in the first RO group and the available RO in the at least one second RO group.

For example, refer to FIG. 4b again. It is assumed that a quantity of PRACH repetitions is 2. For the SSB #0, the first RO group includes an RO #0 and an RO #1, the second RO group includes an RO #4 and an RO #5, and the RO resources indicated by the PRACH mask index at the current moment t1 are that the first RO is unavailable and the second RO is available in an SSB-RO mapping cycle. Therefore, for the SSB #0, the RO #1 is available and is used as a starting RO, the RO #4 is an unavailable RO, and the RO #5 is an available RO. Therefore, the terminal may combine the RO #1 in the first RO group and the RO #5 in the second RO group into a target RO group.

(23) Determine that the first RO group cannot be used as the target RO group. That is, in a case that there is an unavailable RO indicated by the PRACH mask index in an RO group, the RO group is considered as invalid, that is, cannot be used for the PRACH repetition.

That the terminal actually uses any one of (21) to (23) to determine the target RO group may be determined through protocol agreement, a high-layer configuration, a network side configuration, or the like. This is not limited herein.

In some other embodiments, for the different indication manners mentioned in the foregoing implementations, the RO resources indicated by the PRACH mask index are associated with or correspond to a target SSB, where the target SSB may be a part of all SSBs related to the PRACH repetition.

For example, it is assumed that there are four SSBs, for example, {SSB #0, SSB #1, SSB #2, SSB #3}, related to the PRACH repetition. The PRACH mask index may indicate only the RO resources associated with the SSB #0 and the SSB #1. Correspondingly, the terminal may select, from the RO resources associated with the SSB #0 and the SSB #1, RO resources, for example, a target RO group, indicated by the PRACH mask index. Therefore, the flexibility or applicability of the indication of the PRACH mask index can be improved.

In some embodiments, in a case that the RO resources indicated by the PRACH mask index are ROs corresponding to the PRACH repetition and another feature combination, a target RO group further determined based on the RO resources indicated by the PRACH mask index also indicates the feature combination.

For example, refer to FIG. 4b again. The PRACH mask index indicates, at the current time point t1, that the RO #1 corresponds to a feature combination of PRACH repetition and message (Msg) 3 repetition. Therefore, the target RO group further determined by the terminal is {RO #1, RO #4}. In this case, it is considered that {RO #1, RO #4} also indicates the feature combination of PRACH repetition and Msg 3 repetition.

In this embodiment, different indication granularities are used to indicate the RO resources for the PRACH repetition. Therefore, the flexibility of indication of the RO resources can be improved.

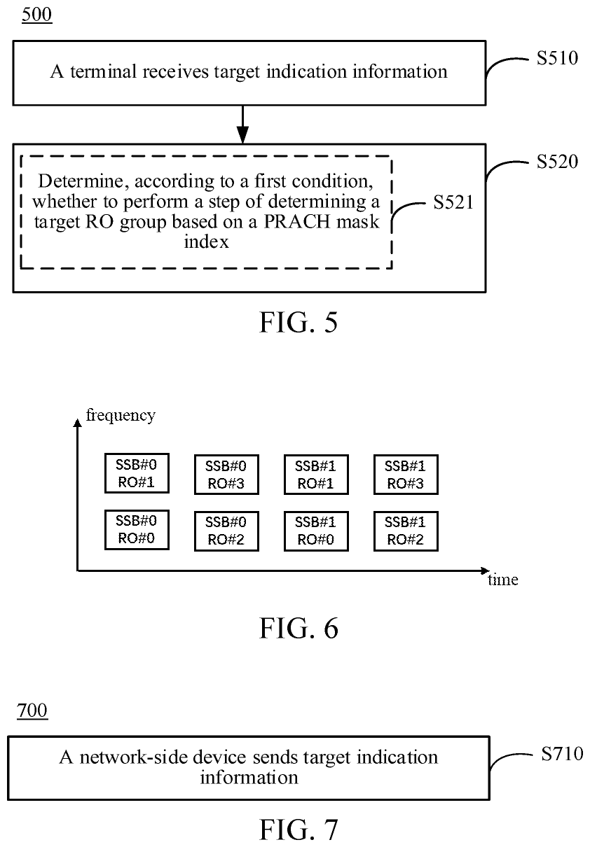

FIG. 5 is a schematic flowchart of a method 500 for determining RO resources according to an example embodiment of this application. The method 500 may be, but is not limited to, performed by a terminal, and may be performed by hardware or software installed in the terminal. In this embodiment, the method 500 may include at least the following steps.

S510: A terminal receives target indication information, where the target indication information includes a PRACH mask index, and the PRACH mask index indicates RO resources during PRACH repetition.

S520: Determine a target RO group based on the PRACH mask index, where the target RO group is used for the PRACH repetition.

It may be understood that, for implementation processes of S510 and S520, refer to related descriptions in the foregoing method embodiment 200 or 300, and the same or corresponding technical effects can be achieved. In addition to referring to related descriptions in the foregoing method embodiment 200 or 300, in some embodiments, for example, in S521 shown in FIG. 5, this application may further determine, according to a first condition, whether to perform the step of determining the target RO group based on the PRACH mask index, to determine adaptability of the technical solution provided in this application and an application scenario of the technical solution, thereby ensuring validity of a communication system.

S521: Determine, according to a first condition, whether to perform the step of determining the target RO group based on the PRACH mask index.

In some embodiments, the first condition may include, but is not limited to, at least one of (31) to (33).

(31) Whether a time offset value is configured, where the time offset value is related to the PRACH repetition.

For example, in a case that the time offset value is not configured, the terminal performs the step of determining the target RO group based on the PRACH mask index. That is, the network-side device uses the PRACH mask index to indicate the RO resources during the PRACH repetition.

In some alternative embodiments, in a case that the time offset value is configured, the terminal does not perform the step of determining the target RO group based on the PRACH mask index. That is, the network-side device does not use the PRACH mask index to indicate the RO resources during the PRACH repetition.

(32) Whether the ROs associated with the same SSB include the ROs having the same frequency-domain position in a target period, where the SSB is related to the PRACH repetition.

For example, in an SSB-RO mapping cycle, in a case that the ROs associated with the same SSB do not include the ROs having the same frequency-domain position, the terminal performs the step of determining the target RO group based on the PRACH mask index, that is, the network-side device uses the PRACH mask index to indicate the RO resources during the PRACH repetition. In this way, a problem in the related technology may be resolved that consecutive ROs associated with a same SSB may include ROs having a same frequency-domain position, and a terminal behavior may be unclear due to that an RO group determined by the terminal includes an unavailable RO indicated by the PRACH mask.

In some alternative embodiments, in a case that the ROs associated with the same SSB include the ROs having the same frequency-domain position, the terminal does not perform the step of determining the target RO group based on the PRACH mask index, that is, the network-side device does not use the PRACH mask index to indicate the RO resources during the PRACH repetition.

For example, as shown in FIG. 6, it is assumed that there are two SSBs in total, namely, an SSB #0 and an SSB #1 shown in FIG. 6, and a quantity of ROs multiplexed in frequency domain is 2. Each SSB is associated with four consecutive ROs. In this case, in one SSB-RO mapping cycle, the ROs associated with the same SSB include the ROs having the same frequency-domain position. In this case, the PRACH mask index cannot be used to indicate the RO resources during the PRACH repetition.

In view of this, in an implementation, whether the ROs associated with the same SSB include the ROs having the same frequency-domain position includes: whether the ROs associated with the same SSB include the ROs having the same frequency-domain position in a target period. The target period includes at least one of the following: an SSB-RO mapping cycle; an SSB-RO association period; an SSB-RO association pattern period; and a target time period, where the target time period is a time period for determining the target RO group.

(33) Whether 1/N is greater than a quantity of ROs on which frequency-domain multiplexing is performed, where N is a quantity of SSBs associated with a same RO. The RO is related to the PRACH repetition.

Refer to FIG. 6 again. It is assumed that there are two SSBs in total, namely, an SSB #0, an SSB #1 shown in FIG. 6, and a quantity of ROs multiplexed in frequency domain is 2. Each SSB is associated with four consecutive ROs, that is, 1/N=4. In this case, the PRACH mask index cannot be used to indicate the RO resources during the PRACH repetition.

In some other embodiments, in this application, it may be determined, based on whether a second condition is met, whether to determine the target RO group based on the PRACH mask index. For example, in a case that the second condition is met, it is determined to perform the step of determining the target RO group based on the PRACH mask index or it is determined to perform the PRACH repetition. In this way, it can be avoided that an unavailable RO indicated by the PRACH mask index exists in the target RO group determined by the terminal, so that the terminal can send the PRACH on all ROs in the RO group, thereby facilitating performance of the PRACH repetition.

The second condition includes that in one SSB-RO mapping cycle, there are at least two available ROs in the ROs associated with the SSB that are indicated by the PRACH mask index, and the SSB is related to the PRACH repetition.

That is, for the PRACH repetition, in one SSB-RO mapping cycle, in a case that more than one RO is available in ROs associated with a specific SSB that are indicated by the PRACH mask index, the PRACH repetition is supported. For example, the PRACH repetition is supported in a case that all ROs associated with a specific SSB that are indicated by the PRACH mask index are available ROs. On the contrary, in a case that one or none of the ROs associated with a specific SSB that are indicated by the PRACH mask index is available, the PRACH repetition is not supported.

For example, it is assumed that in one SSB-RO mapping cycle, the PRACH mask index can only indicate that all ROs associated with the SSB are available, all ROs with an odd number are available, or all ROs with an even number are available. Therefore, as shown in FIG. 6, in a case that the PRACH mask index indicates that only the ROs with an odd number are available, the available ROs for the SSB #0 are {SSB #0 RO #0, SSB #0 RO #2}, and the available ROs for the SSB #1 are {SSB #1 RO #0, SSB #1 RO #2}. In this case, the PRACH repetition may be allowed.

It should be noted that whether to perform S520 may be determined according to the first condition or the second condition, or may be determined by both the first condition and the second condition. This is not limited herein.

In this embodiment, in a case that the RO resources for the PRACH repetition are indicated, an application condition, such as the foregoing first condition and second condition, of limiting the PRACH mask index during the PRACH repetition can be used to improve the effectiveness of the PRACH repetition.

FIG. 7 is a schematic flowchart of a method 700 for determining RO resources according to an example embodiment of this application. The method 700 may be, but is not limited to, performed by a network-side device, and may be performed by hardware or software installed in the network-side device. In this embodiment, the method 700 may include at least the following steps.

S710: A network-side device sends target indication information, where the target indication information includes a physical random access channel PRACH mask index, and the PRACH mask index indicates RO resources during PRACH repetition.

In some embodiments, in a case that the PRACH mask index indicates that an indication granularity of the RO resources is an RO group, the PRACH mask index is indicated by at least one of the following: indicating that all RO groups associated with the SSB are available; indicating that an RO group associated with the SSB with a group index of an odd number is available; indicating that an RO group associated with the SSB with a group index of an even number is available; and indicating that a specific RO group in a target range is available, where the SSB is related to the PRACH repetition.

In some embodiments, the target range includes at least one of the following: a target time period, where the target time period is a time period for determining the target RO group; preset M RO groups, where Mis an integer greater than or equal to 1; at least one SSB-RO mapping cycle; at least one SSB-RO association period; and at least one SSB-RO association pattern period.

In some embodiments, a size of the RO group indicated by the PRACH mask index corresponds to a quantity of repetitions of the PRACH repetition; or a size of the RO group indicated by the PRACH mask index corresponds to a maximum quantity of repetitions in a plurality of different repetitions corresponding to the PRACH repetition.

In some embodiments, in a case that the RO resources are shared in a 2-step random access procedure and a 4-step random access procedure, the RO resources indicated by the PRACH mask index are used in the 2-step random access procedure, and are not used in the 4-step random access procedure.

In some embodiments, the RO resources indicated by the PRACH mask index are associated with a target SSB, and the target SSB is a part of all SSBs related to the PRACH repetition.

In some embodiments, the method further includes: determining, according to a first condition, whether to perform the step of sending the target indication information.

The first condition includes at least one of the following: whether a time offset value is configured; whether a plurality of ROs associated with a same SSB include ROs having a same frequency-domain position; and whether 1/Nis greater than a quantity of ROs on which frequency-domain multiplexing is performed, where N is a quantity of SSBs associated with a same RO, where the time offset value, the SSB, and the RO are related to the PRACH repetition.

In some embodiments, the method further includes: in a case that a second condition is met, determining whether to perform the step of sending the target indication information, where the second condition includes that in one SSB-RO mapping cycle, there are at least two available ROs in the ROs associated with the SSB that are indicated by the PRACH mask index, and the SSB is related to the PRACH repetition.

It may be understood that, the method embodiment 700 has the same or corresponding technical feature with that in the foregoing method embodiment 200, 300, or 500. Therefore, for an implementation process of each implementation mentioned in the method embodiment 700, refer to related descriptions in the method embodiment 200, 300, or 500, and the same or corresponding technical effects can be achieved. To avoid repetition, details are not described herein again.

A method for determining physical random access channel transmission occasion RO resources according to embodiments of this application may be performed by an apparatus for determining physical random access channel transmission occasion RO resources. In embodiments of this application, the apparatus for determining physical random access channel transmission occasion RO resources according to embodiments of this application is described by using an example in which the apparatus for determining physical random access channel transmission occasion RO resources performs the method for determining physical random access channel transmission occasion RO resources.

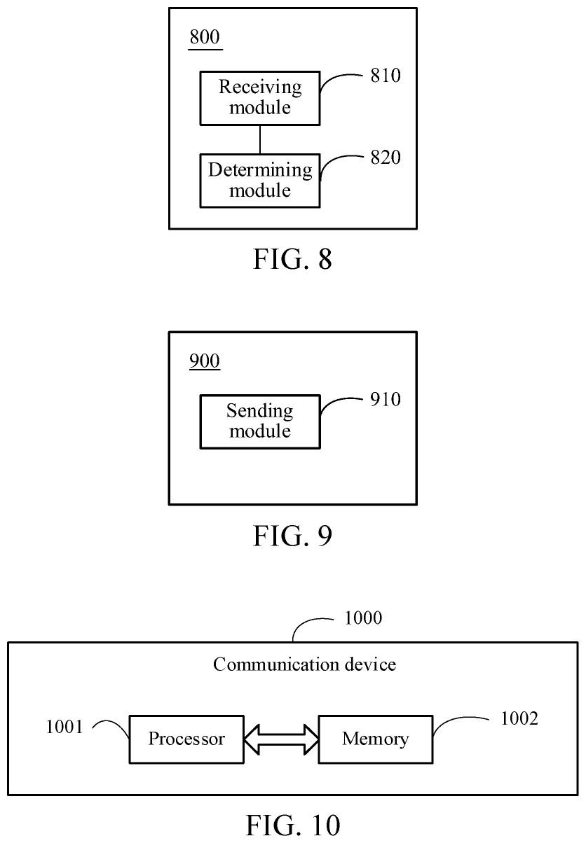

FIG. 8 is a schematic diagram of a structure of an apparatus 800 for determining physical random access channel transmission occasion RO resources according to an embodiment of this application. The apparatus 800 includes: a receiving module 810, configured to receive target indication information, where the target indication information includes a physical random access channel PRACH mask index, and the PRACH mask index indicates RO resources during PRACH repetition; and a determining module 820, configured to determine a target RO group based on the PRACH mask index, where the target RO group is used for the PRACH repetition.

In some embodiments, the determining module 820 is further configured to determine, according to a first condition, whether to perform the step of determining the target RO group based on the PRACH mask index, where the first condition includes at least one of the following: whether a time offset value is configured; whether a plurality of ROs associated with a same SSB include ROs having a same frequency-domain position; and whether 1/N is greater than a quantity of ROs on which frequency-domain multiplexing is performed, where N is a quantity of SSBs associated with a same RO, where the time offset value, the SSB, and the RO are related to the PRACH repetition.

In some embodiments, whether the ROs associated with the same SSB include the ROs having the same frequency-domain position includes: whether the ROs associated with the same SSB include the ROs having the same frequency-domain position in a target period, where the target period includes at least one of the following: an SSB-RO mapping cycle; an SSB-RO association period; an SSB-RO association pattern period; and a target time period, where the target time period is a time period for determining the target RO group.

In some embodiments, the determining module 820 is further configured to: in a case that a second condition is met, determine to perform the step of determining the target RO group based on the PRACH mask index, where the second condition includes that in one SSB-RO mapping cycle, there are at least two available ROs in the ROs associated with the SSB that are indicated by the PRACH mask index, and the SSB is related to the PRACH repetition.

In some embodiments, in a case that the PRACH mask index indicates that an indication granularity of the RO resources is an RO group, the PRACH mask index is indicated by at least one of the following: indicating that all RO groups associated with the SSB are available; indicating that an RO group associated with the SSB with a group index of an odd number is available; indicating that an RO group associated with the SSB with a group index of an even number is available; and indicating that a specific RO group in a target range is available, where the SSB is related to the PRACH repetition.

In some embodiments, the target range includes at least one of the following: a target time period, where the target time period is a time period for determining the target RO group; preset M RO groups, where Mis an integer greater than or equal to 1; at least one SSB-RO mapping cycle; at least one SSB-RO association period; and at least one SSB-RO association pattern period.

In some embodiments, a size of the RO group indicated by the PRACH mask index corresponds to a quantity of repetitions of the PRACH repetition; or a size of the RO group indicated by the PRACH mask index corresponds to a maximum quantity of repetitions in a plurality of different repetitions corresponding to the PRACH repetition.

In some embodiments, in a case that the size of the RO group indicated by the PRACH mask index corresponds to the maximum quantity of repetitions in different repetitions, that the determining module 820 determines the target RO group based on the PRACH mask index includes: in a case that the quantity of repetitions of the PRACH repetition performed by the terminal is less than the maximum quantity of repetitions, determining the target RO group based on a part of ROs in the RO group indicated by the PRACH mask index.

In some embodiments, in a case that the PRACH mask index indicates that an indication granularity of the RO resources is the RO, that the determining module 820 determines the target RO group based on the PRACH mask index includes at least one of the following: using, as the target RO group, an available RO group including the ROs indicated by the PRACH mask index, where all ROs in the available RO group are after a current time point, and the current time point is a time point of receiving the target indication information; using the RO indicated by the PRACH mask index as a starting RO, and determining the target RO group based on the starting RO; and in a case that the PRACH mask index indicates the plurality of ROs, determining the target RO group based on available ROs in the plurality of ROs.

In some embodiments, each of the plurality of ROs corresponds to a different SSB-RO mapping cycle.

In some embodiments, that the determining module 820 determines the target RO group based on the PRACH mask index includes: in a case that the terminal determines in advance that there is a first RO group, and the first RO group includes an unavailable RO and an available RO that are indicated by the PRACH mask index, performing, by the terminal, any one of the following: determining the first RO group as the target RO group; determining that the first RO group cannot be used as the target RO group; and determining the target RO group based on the available RO in the first RO group and an available RO in a second RO group, where the second RO group is located after the first RO group in time.

In some embodiments, in a case that determining the first RO group as the target RO group, the apparatus further includes: a sending module, configured to perform the PRACH repetition on an available RO other than the unavailable RO in the target RO group; or perform the PRACH repetition on an unavailable RO in the target RO group; or perform the PRACH repetition on all ROs in the target RO group.

In some embodiments, in a case that the RO resources are shared in a 2-step random access procedure and a 4-step random access procedure, the RO resources indicated by the PRACH mask index are used in the 2-step random access procedure, and are not used in the 4-step random access procedure.

In some embodiments, the RO resources indicated by the PRACH mask index are associated with a target SSB, and the target SSB is a part of all SSBs related to the PRACH repetition.

The apparatus 800 for determining physical random access channel transmission occasion RO resources in embodiments of this application may be an electronic device, for example, an electronic device having an operating system, or may be a component, for example, an integrated circuit or a chip in an electronic device. The electronic device may be a terminal, or may be another device other than a terminal. For example, the terminal may include, but is not limited to, the types of the terminal 11 listed above, and the another device may be a server, a Network Attached Storage (NAS), or the like. This is not limited in embodiments of this application.

The apparatus 800 for determining physical random access channel transmission occasion RO resources provided in embodiments of this application can implement all processes implemented by the method embodiment of FIG. 2 to FIG. 5, and the same technical effects can be achieved. To avoid repetition, details are not described herein again.

FIG. 9 is a schematic diagram of a structure of an apparatus 900 for determining physical random access channel transmission occasion RO resources according to an embodiment of this application. The apparatus 900 includes: a sending module 910, configured to send target indication information, where the target indication information includes a physical random access channel PRACH mask index, and the PRACH mask index indicates RO resources during PRACH repetition.

In some embodiments, in a case that the PRACH mask index indicates that an indication granularity of the RO resources is an RO group, the PRACH mask index is indicated by at least one of the following: indicating that all RO groups associated with the SSB are available; indicating that an RO group associated with the SSB with a group index of an odd number is available; indicating that an RO group associated with the SSB with a group index of an even number is available; and indicating that a specific RO group in a target range is available, where the SSB is related to the PRACH repetition.

In some embodiments, the target range includes at least one of the following: a target time period, where the target time period is a time period for determining the target RO group; preset M RO groups, where Mis an integer greater than or equal to 1; at least one SSB-RO mapping cycle; at least one SSB-RO association period; and at least one SSB-RO association pattern period.

In some embodiments, a size of the RO group indicated by the PRACH mask index corresponds to a quantity of repetitions of the PRACH repetition; or a size of the RO group indicated by the PRACH mask index corresponds to a maximum quantity of repetitions in a plurality of different repetitions corresponding to the PRACH repetition.

In some embodiments, in a case that the RO resources are shared in a 2-step random access procedure and a 4-step random access procedure, the RO resources indicated by the PRACH mask index are used in the 2-step random access procedure, and are not used in the 4-step random access procedure.

In some embodiments, the RO resources indicated by the PRACH mask index are associated with a target SSB, and the target SSB is a part of all SSBs related to the PRACH repetition.

The apparatus 900 for determining physical random access channel transmission occasion RO resources in this embodiment of this application may be a network-side device. For example, the network-side device may include, but is not limited to, the type of the network-side device 12 listed above.

The apparatus 900 for determining physical random access channel transmission occasion RO resources provided in embodiments of this application can implement all processes implemented by the method embodiment of FIG. 7, and the same technical effects can be achieved. To avoid repetition, details are not described herein again.

As shown in FIG. 10, an embodiment of this application further provides a communication device 1000, including a processor 1001 and a memory 1002. The memory 1002 stores a program or instructions that can be run on the processor 1001. For example, in a case that the communication device 1000 is a terminal, each step of the method embodiment for determining physical random access channel transmission occasion RO resources may be performed in a case that the program or the instructions are executed by the processor 1001, and the same technical effect may be achieved. In a case that the communication device 1000 is a network-side device, each step of the method embodiment for determining physical random access channel transmission occasion RO resources may be performed in a case that the program or the instructions are executed by the processor 1001, and the same technical effect may be achieved. To avoid repetition, details are not described herein again.

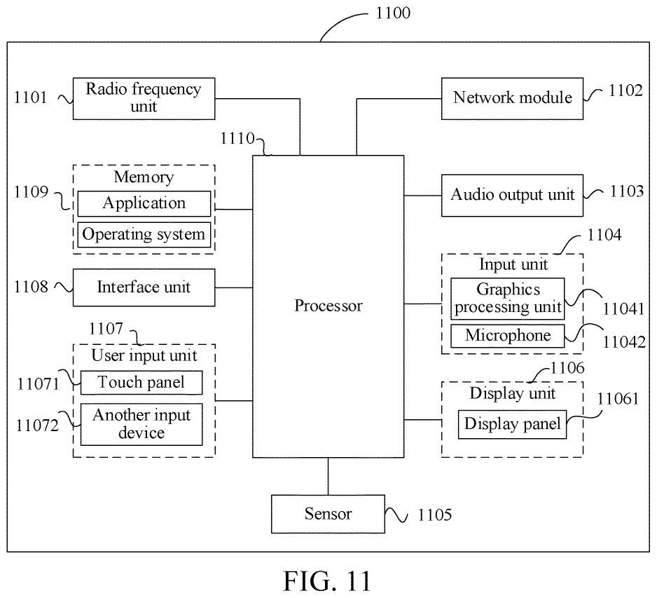

An embodiment of this application further provides a terminal, including a processor and a communication interface. The communication interface is coupled to the processor, and the processor is configured to run a program or instructions, to implement steps in the method embodiment shown in FIG. 2 to FIG. 5. The terminal embodiment corresponds to the foregoing terminal-side method embodiment, and each implementation process and implementation of the foregoing method embodiment may be used in the terminal embodiment, and the same technical effects can be achieved. For example, FIG. 11 is a diagram of a hardware structure of a terminal according to an embodiment of this application.

The terminal 1100 includes, but is not limited to, at least some of components of a radio frequency unit 1101, a network module 1102, an audio output unit 1103, an input unit 1104, a sensor 1105, a display unit 1106, a user input unit 1107, an interface unit 1108, a memory 1109, a processor 1110, and the like.

A person skilled in the art may understand that, the terminal 1100 may further include a power supply (for example, a battery) for supplying power to the components. The power supply may be logically connected to the processor 1110 by using a power management system, to implement functions such as charging, discharging, and power consumption management by using the power management system. The structure of the terminal shown in FIG. 11 constitutes no limitation on the terminal. The terminal may include more or fewer components than those shown in the figure, or combine some components, or have different component arrangements. Details are not described herein again.

It should be understood that, in this embodiment of this application, the input unit 1104 may include a Graphics Processing Unit (GPU) 11041 and a microphone 11042. The graphics processing unit 11041 performs processing on image data of a static image or a video that is obtained by an image capture apparatus (for example, a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and another input device 11072. The touch panel 11071 is referred to as a touchscreen. The touch panel 11071 may include two parts: a touch detection apparatus and a touch controller. The another input device 11072 may include, but is not limited to, a physical keyboard, a function button (for example, a volume control button, a power button, or the like), a trackball, a mouse, and a joystick. Details are not described herein again.

In this embodiment of this application, the radio frequency unit 1101 receives downlink data from a network-side device and then transmits the data to the processor 1110 for processing. In addition, the radio frequency unit 1101 may send uplink data to the network-side device. Generally, the radio frequency unit 1101 includes, but is not limited to, an antenna, an amplifier, a transceiver, a coupler, a low noise amplifier, a duplexer, and the like.

The memory 1109 may be configured to store a software program or instructions and various data. The memory 1109 may mainly include a first storage area for storing the program and the instructions and a second storage area for storing the data. The first storage area may store an operating system, an application or instructions required by at least one function (for example, a sound playback function, an image display function, and the like), and the like. In addition, the memory 1109 may include a volatile memory or a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 1109 in this embodiment of this application includes, but is not limited to, these memories and any memory of another proper type.

The processor 1110 may include one or more processing units. In some embodiments, the processor 1110 integrates an application processor and a modem processor. The application processor mainly processes operations related to an operating system, a user interface, an application, and the like. The modem processor mainly processes wireless communication signals, and is, for example, a baseband processor. It may be understood that, the foregoing modem processor may not be integrated into the processor 1110.

The radio frequency unit 1101 is configured to receive target indication information, where the target indication information includes a physical random access channel PRACH mask index, and the PRACH mask index indicates RO resources during PRACH repetition; and the processor 1110 is configured to determine a target RO group based on the PRACH mask index, where the target RO group is used for the PRACH repetition.

In some embodiments, the processor 1110 is further configured to determine, according to a first condition, whether to perform the step of determining the target RO group based on the PRACH mask index, where the first condition includes at least one of the following: whether a time offset value is configured; whether a plurality of ROs associated with a same SSB include ROs having a same frequency-domain position; and whether 1/N is greater than a quantity of ROs on which frequency-domain multiplexing is performed, where N is a quantity of SSBs associated with a same RO, where the time offset value, the SSB, and the RO are related to the PRACH repetition.

In some embodiments, whether the ROs associated with the same SSB include the ROs having the same frequency-domain position includes: whether the ROs associated with the same SSB include the ROs having the same frequency-domain position in a target period, where the target period includes at least one of the following: an SSB-RO mapping cycle; an SSB-RO association period; an SSB-RO association pattern period; and a target time period, where the target time period is a time period for determining the target RO group.

In some embodiments, the processor 1110 is further configured to: in a case that a second condition is met, determine to perform the step of determining the target RO group based on the PRACH mask index, where the second condition includes that in one SSB-RO mapping cycle, there are at least two available ROs in the ROs associated with the SSB that are indicated by the PRACH mask index, and the SSB is related to the PRACH repetition.

In some embodiments, in a case that the PRACH mask index indicates that an indication granularity of the RO resources is an RO group, the PRACH mask index is indicated by at least one of the following: indicating that all RO groups associated with the SSB are available; indicating that an RO group associated with the SSB with a group index of an odd number is available; indicating that an RO group associated with the SSB with a group index of an even number is available; and indicating that a specific RO group in a target range is available, where the SSB is related to the PRACH repetition.

In some embodiments, the target range includes at least one of the following: a target time period, where the target time period is a time period for determining the target RO group; preset M RO groups, where Mis an integer greater than or equal to 1; at least one SSB-RO mapping cycle; at least one SSB-RO association period; and at least one SSB-RO association pattern period.

In some embodiments, a size of the RO group indicated by the PRACH mask index corresponds to a quantity of repetitions of the PRACH repetition; or a size of the RO group indicated by the PRACH mask index corresponds to a maximum quantity of repetitions in a plurality of different repetitions corresponding to the PRACH repetition.

In some embodiments, in a case that the size of the RO group indicated by the PRACH mask index corresponds to the maximum quantity of repetitions in different repetitions, that the processor 1110 determines the target RO group based on the PRACH mask index includes: in a case that the quantity of repetitions of the PRACH repetition performed by the terminal is less than the maximum quantity of repetitions, determining the target RO group based on a part of ROs in the RO group indicated by the PRACH mask index.

In some embodiments, in a case that the PRACH mask index indicates that an indication granularity of the RO resources is the RO, that the processor 1110 determines the target RO group based on the PRACH mask index includes at least one of the following: using, as the target RO group, an available RO group including the ROs indicated by the PRACH mask index, where all ROs in the available RO group are after a current time point, and the current time point is a time point of receiving the target indication information; using the RO indicated by the PRACH mask index as a starting RO, and determining the target RO group based on the starting RO; and in a case that the PRACH mask index indicates the plurality of ROs, determining the target RO group based on available ROs in the plurality of ROs.

In some embodiments, each of the plurality of ROs corresponds to a different SSB-RO mapping cycle.

In some embodiments, that the processor 1110 determines the target RO group based on the PRACH mask index includes: in a case that the terminal determines in advance that there is a first RO group, and the first RO group includes an unavailable RO and an available RO that are indicated by the PRACH mask index, performing, by the terminal, any one of the following: determining the first RO group as the target RO group; determining that the first RO group cannot be used as the target RO group; and determining the target RO group based on the available RO in the first RO group and an available RO in a second RO group, where the second RO group is located after the first RO group in time.

In some embodiments, in a case that determining the first RO group as the target RO group, the apparatus further includes: a radio frequency unit 1101, configured to perform the PRACH repetition on an available RO other than the unavailable RO in the target RO group; or perform the PRACH repetition on an unavailable RO in the target RO group; or perform the PRACH repetition on all ROs in the target RO group.

In some embodiments, in a case that the RO resources are shared in a 2-step random access procedure and a 4-step random access procedure, the RO resources indicated by the PRACH mask index are used in the 2-step random access procedure, and are not used in the 4-step random access procedure.

In some embodiments, the RO resources indicated by the PRACH mask index are associated with a target SSB, and the target SSB is a part of all SSBs related to the PRACH repetition.

It may be understood that, for an implementation process of each implementation mentioned in this embodiment, refer to related descriptions in the method embodiments 200 to 400, and the same or corresponding technical effects can be achieved. To avoid repetition, details are not described herein again.

An embodiment of this application further provides a network-side device, including a processor and a communication interface. The communication interface is coupled to the processor, and the processor is configured to run a program or instructions, to implement steps of the method embodiment shown in FIG. 7. The network-side device embodiment corresponds to the foregoing network-side device method embodiment, and each implementation process and implementation of the foregoing method embodiment may be used in the network-side device embodiment, and the same technical effects can be achieved.

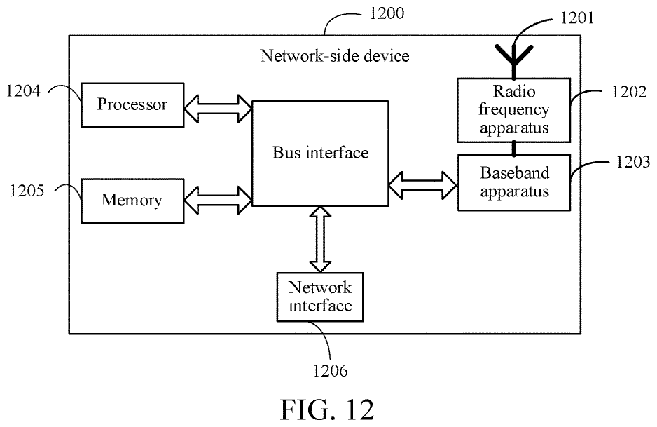

An embodiment of this application further provides a network-side device. As shown in FIG. 12, the network-side device 1200 includes: an antenna 1201, a radio frequency apparatus 1202, a baseband apparatus 1203, a processor 1204, and a memory 1205. The antenna 1201 is connected to the radio frequency apparatus 1202. In an uplink direction, the radio frequency apparatus 1202 receives information through the antenna 1201 and sends the received information to the baseband apparatus 1203 for processing. In a downlink direction, the baseband apparatus 1203 processes to-be-sent information and sends the information to the radio frequency apparatus 1202, and the radio frequency apparatus 1202 processes the received information and sends the information through the antenna 1201.

The method performed by the network-side device in the foregoing embodiment may be implemented in the baseband apparatus 1203. The baseband apparatus 1203 includes a baseband processor.

The baseband apparatus 1203 may include, for example, at least one baseband board, and a plurality of chips are disposed on the baseband board. As shown in FIG. 12, one of the chips is, for example, the baseband processor, connected to the memory 1205 through a bus interface, to invoke a program in the memory 1205, and perform an operation performed by the network device shown in the foregoing method embodiment.

The network-side device may further include a network interface 1206. The interface is, for example, a Common Public Radio Interface (CPRI).

For example, the network-side device 1200 in this embodiment of the present disclosure further includes: instructions or a program stored in the memory 1205 and executable on the processor 1204. The processor 1204 invokes the instructions or the program in the memory 1205 to perform the method performed by each module shown in FIG. 8, and achieves the same technical effects. To avoid repetition, details are not described herein again.

An embodiment of this application further provides a readable storage medium. The readable storage medium stores a program or instructions, and in a case that the program or the instructions are executed by a processor, each process of the method embodiment for determining physical random access channel transmission occasion RO resources is implemented, and the same technical effects may be achieved. To avoid repetition, details are not described herein again.

The processor is the processor in the terminal described in the foregoing embodiment. The readable storage medium includes a computer-readable storage medium, for example, a computer read-only memory ROM, a random access memory RAM, a magnetic or an optical disc, or the like. In some examples, the readable storage medium may be a non-transient readable storage medium.

An embodiment of this application further provides a chip. The chip includes a processor and a communication interface. The communication interface is coupled to the processor. The processor is configured to run a program or instructions, to implement each process of the method embodiment for determining physical random access channel transmission occasion RO resources, and the same technical effects can be achieved. To avoid repetition, details are not described herein again.

It should be understood that, the chip in this embodiment of this application may be referred to as a system-level chip, a system chip, a chip system, a system-on-chip, or the like.

An embodiment of this application further provides a computer program/program product. The computer program/program product is stored in a storage medium, and the computer program/program product is executed by at least one processor, to implement each process of the method embodiment for determining physical random access channel transmission occasion RO resources, and the same technical effects may be achieved. To avoid repetition, details are not described herein again.

An embodiment of this application further provides a communication system, including: a terminal and a network-side device. The terminal is configured to implement each process of the method embodiments 200 to 500 for determining physical random access channel transmission occasion RO resources; the network-side device is configured to perform each process of the method embodiment 700 for determining physical random access channel transmission occasion RO resources; and the same technical effects can be achieved. To avoid repetition, details are not described herein again.

It should be noted that, the terms “include”, “comprise”, or any other variation thereof in this specification is intended to cover a non-exclusive inclusion, so that a process, a method, an article, or an apparatus that includes a list of elements not only includes those elements but also includes other elements that are not expressly listed, or further includes elements inherent to such a process, a method, an article, or an apparatus. An element preceded by “includes a” does not, without more constraints, preclude the presence of additional identical elements in the process, the method, the article, or the apparatus that includes the element. In addition, it should be noted that, scopes of the method and the apparatus in the implementations of this application are not limited to performing functions in an order shown or discussed, but may include performing functions in a substantially concurrent manner or in reverse order depending on functionality involved. For example, the methods described may be performed in an order different from that described, and various steps may be added, omitted, or combined. In addition, features described with reference to some examples may be combined in another example.

According to the descriptions of the foregoing implementations, a person skilled in the art may clearly learn that the method according to the foregoing embodiment may be implemented by a computer software product in addition to a necessary universal hardware platform, or by using hardware. The computer software product is stored in a storage medium (for example, a ROM, a RAM, a magnetic disk, an optical disc, or the like) including several instructions to enable a terminal or a network-side device to perform the methods described in embodiments of this application.

Embodiments of this application are described with reference to the accompanying drawings. This application is not limited to the implementations described above, and the implementations described above are merely examples and not limited. A person of ordinary skill in the art may also make various forms of implementations under the inspiration of this application and without departing from the purpose of this application and the protection scope of the claims, and such implementations shall all fall within the protection scope of this application.

What is claimed is:

1. A method for determining physical random access channel transmission occasion (RO) resources, comprising:
receiving, by a terminal, target indication information, wherein: the target indication information comprises a Physical Random Access Channel (PRACH) mask index, and the PRACH mask index indicates RO resources during PRACH repetition; and
determining a target RO group based on the PRACH mask index, wherein the target RO group is used for the PRACH repetition.

2. The method according to claim 1, further comprising:
determining, according to a first condition, whether to perform determining the target RO group based on the PRACH mask index, wherein
the first condition comprises at least one of the following:
whether a time offset value is configured;
whether a plurality of ROs associated with a same Synchronization Signal and PBCH block (SSB) comprise ROs having a same frequency-domain position; or
whether 1/N is greater than a quantity of ROs on which frequency-domain multiplexing is performed, wherein N is a quantity of SSBs associated with a same RO, wherein the time offset value, the SSB, and the RO are related to the PRACH repetition.

3. The method according to claim 2, wherein whether the ROs associated with the same SSB comprise the ROs having the same frequency-domain position comprises:
whether the ROs associated with the same SSB comprise the ROs having the same frequency-domain position in a target period, wherein
the target period comprises at least one of the following:
an SSB-RO mapping cycle;
an SSB-RO association period;
an SSB-RO association pattern period; or
a target time period, wherein the target time period is a time period for determining the target RO group.

4. The method according to claim 1, further comprising:
when a second condition is met, determining to perform determining the target RO group based on the PRACH mask index, wherein
the second condition comprises that in one Synchronization Signal and PBCH block (SSB)-RO mapping cycle, there are at least two available ROs in the ROs associated with the SSB that are indicated by the PRACH mask index, and the SSB is related to the PRACH repetition.

5. The method according to claim 1, wherein when the PRACH mask index indicates that an indication granularity of the RO resources is an RO group, the PRACH mask index is indicated by at least one of the following:
indicating that all RO groups associated with a Synchronization Signal and PBCH block (SSB) are available;
indicating that an RO group associated with the SSB with a group index of an odd number is available;
indicating that an RO group associated with the SSB with a group index of an even number is available; or
indicating that a specific RO group in a target range is available, wherein
the SSB is related to the PRACH repetition.

6. The method according to claim 5, wherein the target range comprises at least one of the following:
the target time period, wherein the target time period is a time period for determining the target RO group;
preset M RO groups, wherein M is an integer greater than or equal to 1;
at least one SSB-RO mapping cycle;
at least one SSB-RO association period; and
at least one SSB-RO association pattern period.

7. The method according to claim 1, wherein a size of the RO group indicated by the PRACH mask index corresponds to a quantity of repetitions of the PRACH repetition;
or
a size of the RO group indicated by the PRACH mask index corresponds to a maximum quantity of repetitions in a plurality of different repetitions corresponding to the PRACH repetition.

8. The method according to claim 7, wherein when the size of the RO group indicated by the PRACH mask index corresponds to the maximum quantity of repetitions in different repetitions, determining the target RO group based on the PRACH mask index comprises:
when the quantity of repetitions of the PRACH repetition performed by the terminal is less than the maximum quantity of repetitions, determining, by the terminal, the target RO group based on a part of ROs in the RO group indicated by the PRACH mask index.

9. The method according to claim 1, wherein when the PRACH mask index indicates that an indication granularity of the RO resources is an RO, determining the target RO group based on the PRACH mask index comprises at least one of the following:
using, as the target RO group, an available RO group comprising the ROs indicated by the PRACH mask index, wherein all ROs in the available RO group are after a current time point, and the current time point is a time point of receiving the target indication information;
using the RO indicated by the PRACH mask index as a starting RO, and determining the target RO group based on the starting RO; or
when the PRACH mask index indicates the plurality of ROs, determining the target RO group based on available ROs in the plurality of ROs.

10. The method according to claim 9, wherein each of the plurality of ROs corresponds to a different SSB-RO mapping cycle.

11. The method according to claim 1, wherein determining the target RO group based on the PRACH mask index comprises:
when the terminal determines in advance that there is a first RO group, and the first RO group comprises an unavailable RO and an available RO that are indicated by the PRACH mask index, performing, by the terminal, any one of the following:
determining that the first RO group cannot be used as the target RO group;
determining the first RO group as the target RO group; and
determining the target RO group based on the available RO in the first RO group and an available RO in a second RO group, wherein the second RO group is located after the first RO group in time.

12. The method according to claim 11, wherein when determining the first RO group as the target RO group, the method further comprises:
performing, by the terminal, the PRACH repetition on an available RO other than the unavailable RO in the target RO group;
or
performing, by the terminal, the PRACH repetition on an unavailable RO in the target RO group;
or
performing, by the terminal, the PRACH repetition on all ROs in the target RO group.

13. The method according to claim 1, wherein when the RO resources are shared in a 2-step random access procedure and a 4-step random access procedure, the RO resources indicated by the PRACH mask index are used in the 2-step random access procedure, and are not used in the 4-step random access procedure.

14. The method according to claim 1, wherein the RO resources indicated by the PRACH mask index are associated with a target Synchronization Signal and PBCH block (SSB), and the target SSB is a part of all SSBs related to the PRACH repetition.

15. A terminal, comprising: a processor; and a memory storing a program or instructions, wherein the program or the instructions, when executed by the processor, cause the processor to perform operations comprising:
receiving target indication information, wherein: the target indication information comprises a Physical Random Access Channel (PRACH) mask index, and the PRACH mask index indicates physical random access channel transmission occasion (RO) resources during PRACH repetition; and
determining a target RO group based on the PRACH mask index, wherein the target RO group is used for the PRACH repetition.

16. The terminal according to claim 15, wherein determining the target RO group based on the PRACH mask index comprises:
when the processor determines in advance that there is a first RO group, and the first RO group comprises an unavailable RO and an available RO that are indicated by the PRACH mask index, performing any one of the following:
determining that the first RO group cannot be used as the target RO group;
determining the first RO group as the target RO group; and
determining the target RO group based on the available RO in the first RO group and an available RO in a second RO group, wherein the second RO group is located after the first RO group in time.

17. The terminal according to claim 16, wherein when determining the first RO group as the target RO group, the operations further comprise:
performing the PRACH repetition on an available RO other than the unavailable RO in the target RO group;
or
performing the PRACH repetition on an unavailable RO in the target RO group;
or
performing the PRACH repetition on all ROs in the target RO group.

18. A non-transitory computer-readable storage medium storing a program or instructions that, when executed by a processor, cause the processor to perform operations comprising:
receiving target indication information, wherein: the target indication information comprises a Physical Random Access Channel (PRACH) mask index, and the PRACH mask index indicates physical random access channel transmission occasion (RO) resources during PRACH repetition; and
determining a target RO group based on the PRACH mask index, wherein the target RO group is used for the PRACH repetition.

19. The non-transitory computer-readable storage medium according to claim 18, wherein determining the target RO group based on the PRACH mask index comprises:
when the processor determines in advance that there is a first RO group, and the first RO group comprises an unavailable RO and an available RO that are indicated by the PRACH mask index, performing any one of the following:
determining that the first RO group cannot be used as the target RO group;
determining the first RO group as the target RO group; and
determining the target RO group based on the available RO in the first RO group and an available RO in a second RO group, wherein the second RO group is located after the first RO group in time.

20. The non-transitory computer-readable storage medium according to claim 19, wherein when determining the first RO group as the target RO group, the operations further comprise:
performing the PRACH repetition on an available RO other than the unavailable RO in the target RO group;
or
performing the PRACH repetition on an unavailable RO in the target RO group;
or
performing the PRACH repetition on all ROs in the target RO group.
